(19) United States
(12) Patent Application Publication
(10) Pub. No.: US 2004/0255738 A1
(43) Pub. Date: Dec. 23, 2004

(54) Method and device at running webs which have been printed in a high-speed printer

(76) Inventor: Peter Benjaminsson, Ljungby (SE)

Correspondence Address: TAROLLI, SUNDHEIM, COVELL & TUMMINO L.L.P., 526 SUPERIOR AVENUE, SUITE 1111, CLEVEVLAND, OH, 44114, US

(21) Appl. No.: 10/493,773

(22) PCT Filed: Oct. 28, 2002
(86) PCT No.: PCT/SE02/01949

(30) Foreign Application Priority Data
Oct. 29, 2001 (SE) 0103578-1

(51) Int. Cl. B26D 1/00

(52) U.S. Cl. 83/13; 83/368

(57) ABSTRACT

The present invention relates to a method and devide at running webs which preferably have been printed in a high-speed printer. A method and a device are provided for longitudinal cutting of a running, unseparated web in at least two web portions, wherein the unseparated web (2) is printed in a high-speed printer (1) and wherein the unseparated web (2) is cur longitudinally in at least said two web portions (2a, 2b) by means of a cutting means (7). The unseparated web (2) is brought to run between a first and a second edge support (8, 9) such that longitudinal outer edges (2d, 2e), extending in the running direction (T), of the useparated web (2) can cooperate with said edge supports (8, 9). If the width (B) of the unseparated web (2) varies and/or changes, this is read and the second edge support (9) and the cutting means (7) are continuously controlled to move in a lateral direction (S) relative to the running direction (T) of the unseparated web (2) and in dependence of said continuously read variations and/or changes of the width (B) of the unseparated web (2) such that the unseparated web (2) is cut by the cutting means (7) in at least two web portions (2a, 2b) with widths (B2a, B2b) which are adapted to each other. Said method and device can be combined with feeding, cutting and/or reading methods and devices.

The present invention relates to a method and a device at running webs which have been printed in a high-speed printer.

A method for manufacturing printed papers which have been printed in a high-speed printer, is known from EP 0 562 443. At this prior art method, an unseparated web is cut longitudinally in two web portions, but the method does not solve the problem that the longitudinal cut will be incorrect if the width of the unseparated web for some reason varies and/or changes.

U.S. Pat. No. 3,260,142 and U.S. Pat. No. 3,753,381 describe control devices which control the position of an outer edge of a running web and which move cutting means for dividing the web in lateral direction if said web is moved laterally. These control devices neither solve the problem that the longitudinal cutting of the web will be erroneous if the width of the web varies and/or changes.

The object of the present invention has been to bringing about a correct division of the web if the width thereof for some reason varies or changes and which solve the problems with a safe and efficient feeding and cutting of the web portions. This is arrived at while the methods according to the invention are defined by the characterizing measures of subsequent claims 1 and/or 7 and while the devices according to the invention are defined by the characterizing features of subsequent claims 11 and/or 17.

Since the invention is defined by said characterizing measures and features, it is accomplished that the position of the cutting means is continuously adapted to variations and/or changes of the width of the unseparated web such that said web is cut in web portions with widths adapted to each other in dependence of said variations and/or changes. It is also accomplished that the web portions are fed and cut in a safe and efficient manner.

The invention will be further described below with reference to the accompanying drawings, in which

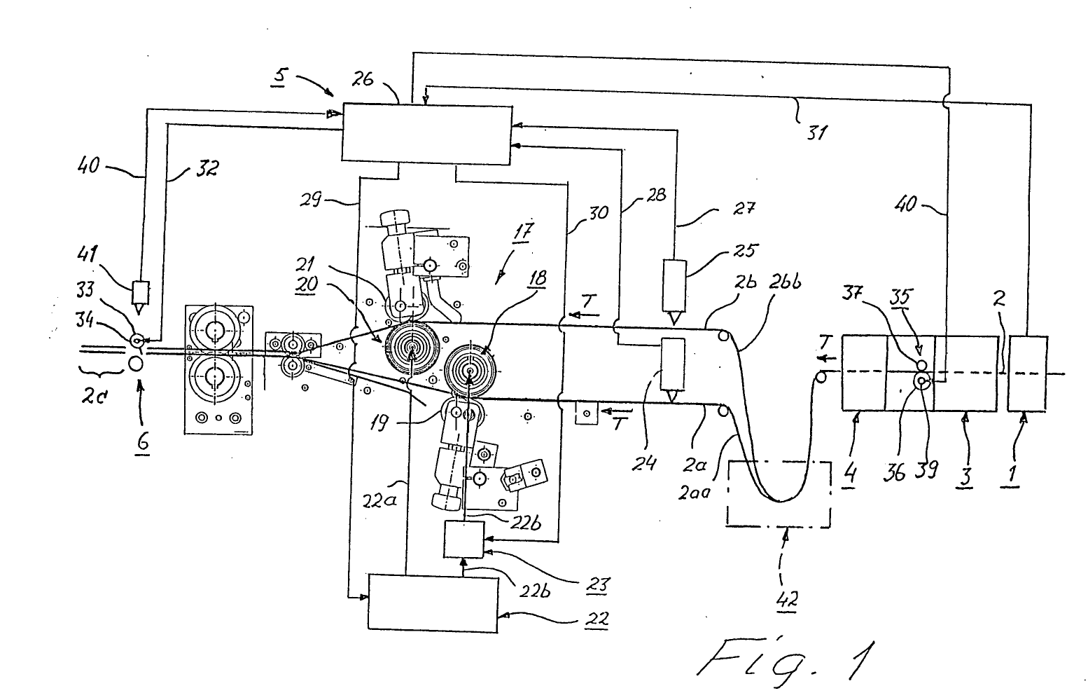

FIG. 1 with a side view schematically illustrates several devices located after each other and among which a device according to the invention constitutes a part; and

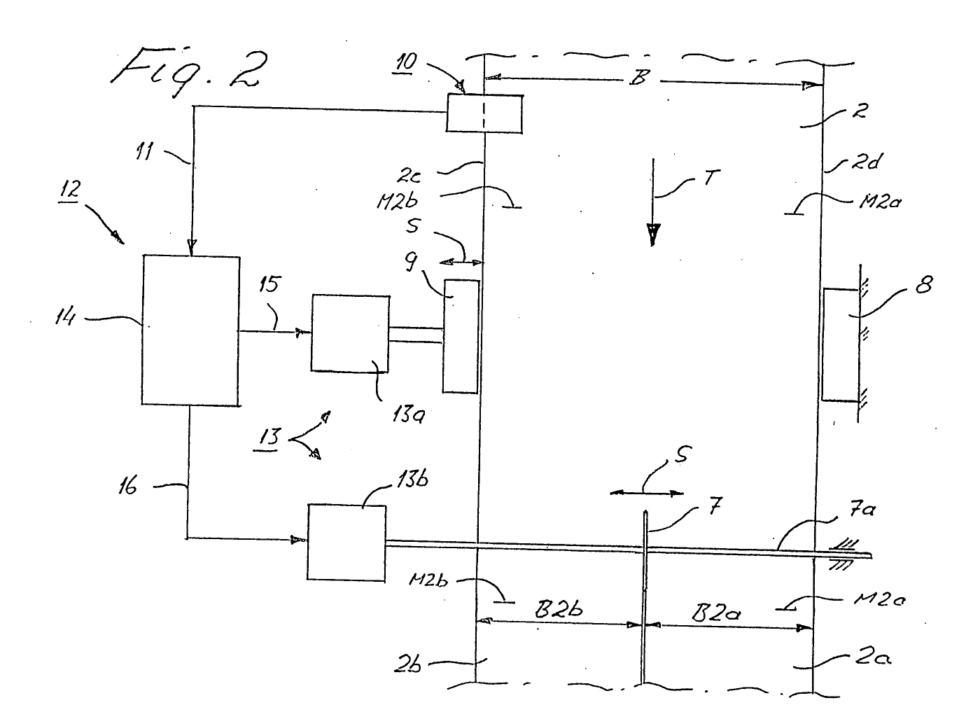

FIG. 2 with an enlarged plan view shows a device according to the invention.

The device illustrated in FIG. 1 includes a high-speed printer 1 for printing a running, unseparated web 2, a length cutting device 3 for longitudinal cutting of the web 2 in two web portions 2a, 2b, a twin-web device 4 for bringing the two web portions 2a, 2b to run above each other as a twin web, a synchronizing device 5 in order to ensure that the web portions 2a, 2b run such that parts thereof have predetermined positions relative to each other and a cross cutting device 6 for cutting the web portions 2a, 2b to double face products 2c.

The unseparated web 2 is preferably fed from a roll (not shown) into the high speed printer 1 and is printed therein as previously stated in a suitable manner. In connection with the printing or on another occasion, the unseparated web 2 may be provided with marks M2a, M2b in such a way that marks M2a will later be found on the web portion 2a and marks M2b on the web portion 2b. The web portions 2a, 2b shall be brought to run synchronized relative to each other such that a part of the web portion 2a with marks M2a will be found in a certain relationship to a corresponding part of the web portion 2b with marks M2b, which will be further described below.

As is apparent from FIG. 2, the length cutting device 3 comprises a cutting means 7 which is adapted to divide the unseparated web 2 into the web portions 2a, 2b and this is carried through continuously when the web 2 moves in the running direction T. The length cutting device 3 further comprises a first edge support 8 and a second edge support 9. The unseparated web 2 is brought to move between said edge supports 8, 9 such that the longitudinal first and second outer edges 2d, 2e thereof extending in the running direction T, cooperate with the edge supports 8, 9, which means that these supports guide the unseparated web 2 not to move laterally relative to the running direction T when it runs through the length cutting device 3.

A reader device 10 is provided for continuously reading if the width B of the running web 2 for some reason varies and/or for some reason changes. If the reader device 10 reads variations and/or changes of the width B of the unseparated web 2, it transmits change signals, arrow 11, to a control device 12 which continuously controls the second edge support 9 (which is movable in lateral directions, arrow S, relative to the running direction T) as well as the cutting means 7 (which is also movable in lateral directions S relative to the running direction T) to continuously move in said lateral directions S based on such variations and/or changes of the width B of the unseparated web 2 read by the reader device 10 such that the cutting means 7 cuts the unseparated web 2 into two web portions 2a, 2b with widths B2a and B2b adapted to each other even if the width B of the unseparated web 2 varies and/or changes.

As an example of functions of said device, it can be mentioned that if the width B of the unseparated web 2 decreases, the reader device 10 transmits corresponding change signals 11 to the control device 12 which moves the second edge support 9 correspondingly to the right and the cutting means 7 is displaced half as much to the right. If the width B of the unseparated web 2 on the other hand increases, the reader device 10 transmits corresponding change signals 11 to the control device 12 which instead moves the second edge support 9 and the cutting means 7 to the left.

The reader device 10 reads the extent or size of said variations and/or changes of the width B of the web 2 and it transmits, depending on this size, change signals 11 to the control device 12 which controls the second edge support 9 and the cutting means 7 to move a distance corresponding to said size-dependent change signals 11.

The reader device 10 is preferably provided such that it continuously reads the actual width B of the unseparated web 2 by reading the actual position of its second outer edge 2e relative to the first edge support 8, which preferably is fixedly mounted.

The control device 12 preferably comprises a driving device 13 for moving the second edge support 9 and the cutting means 7 relative to the first edge support 8. Said 15 driving device 13 may include a first drive unit 13a for moving the second edge support 9 and a second drive unit 13b for moving the cutting means 7. The drive units 13a, 13b may be electric motors and they may be controlled by control signals from a control unit 14 in the control arrows 15 and 16 in FIG. 2.

The cutting means 7 may be rotatably mounted on a shaft 7a which can be displaced in lateral direction S by means of the second drive unit 13b. The cutting means 7 may in a manner known per se be rotatably mounted and cooperate with a drive unit rotating it. The cutting means 7 may further be provided to divide the unseparated web 2 in web portions 2a, 2b having the same width B2a, B2b and in that case it is displaced half the distance relative to the distance the width B of the unseparated web 2 is varied. However, the cutting means 7 may be provided to cut the unseparated web 2 in web portions 2a, 2b having different widths B2a, B2b.

In the twin-web device 4, the two web portions 2a, 2b are brought to run above each other as a twin web. Twin-web devices 4 for this purpose are commonly known and not further described here. It should be mentioned however, that such devices generally have edge guide plates or similar for guiding one web portion 2b to run above the other web portion 2a.

After the twin-web device 4, the web portions 2a, 2b are fed into the synchronizing device 5, which here is combined with a feed device 17. The latter may include a lower friction roll 18 for feeding the lower web portion 2a and this lower friction roll 18 cooperates with a counter-pressure roll 19. The feed device 17 may further include an upper friction roll 20 for feeding the upper web portion 2b and said upper friction roll 20 may cooperate with a counter-pressure roll 21.

The friction rolls 18, 20 are provided to perform, in cooperation with the counter-pressure rolls 19, 21, friction feeding of the web portions 2a, 2b, which means that they shall engage the web portions 2a, 2b with such friction that these are fed in the running direction T.

The friction rolls 18, 20 are in the present embodiment rotated by one and same drive unit 22 (preferably an electric motor), which is illustrated with drive lines 22a, 22b. The upper friction roll 20 is driven directly by the drive unit 22, while the lower friction roll 18 is operated by the drive unit 22 through a rotary-speed regulation device 23, e.g. a variation device or a servo regulator, which can increase or decrease the rotary speed of the friction roll 20.

The synchronizing device 5 preferably comprises a lower reader device 24 for reading the marks M2a on the lower web portion 2a and an upper reader device 25 for reading the marks M2b on the upper web portion 2b. The reader devices 24, 25 cooperate with a control unit 26 such that reading signals, schematically illustrated with arrows 27, 28, are transmitted to the control unit 26. The control unit 26 cooperates in turn with the drive unit 22 for transmitting control signals 29 thereto as well as with the rotary-speed regulating device 23 for transmitting control signals 30 thereto. The control unit 26 receives information signals 31 from the high-speed printer 1 and information signals 41a from the cross cutting device 6.

The synchronizing device 5 operates such that information signals 31 are transmitted from the high-speed printer 1 to the control unit 26 and from said unit as control signals 29 to the drive unit 22 which operates the friction rolls 18, 20 to rotate with a certain rotary speed and thus, the web portions 2a, 2b with a certain running speed. If the running speed of one of the web portions is changed relative to the running speed of the other web portion in an unappropriate manner, this is sensed by the reader devices 24, 25 which sense this change by determining that the marks M2a and M2b do no longer pass them at the same time or at another predetermined moment. If this situation has occurred, control signals 30 are transmitted to the rotary-speed regulating device 23 such that this device increases or decreases the rotary speed of the lower friction roll 18 relative to the rotary speed of the upper friction roll 20 and thus, operates the lower web portion 2a faster or slower than the upper web portion 2b until the web portions 2a, 2b again run relative to each other such that marks M2a, M2b again pass the reader devices 24, 25 in a predetermined manner. Hereby, it is ensured that a certain part of the lower web portion 2a reaches an exact position relative to a corresponding part of the upper web portion 2b when said parts reach the cross cutting device 6 so that they can be located in predetermined exact positions relative to each other.

The cross cutting device 6 may have a rotating cutting means 33, the driving device 34 of which is controlled such that the rotating cutting means 33 cuts the web portions 2a, 2b at the right moment for obtaining products 2c with the correct size. This control of the rotating cutting means 33 is carried through preferably by transmitting information signals 32 from the control unit 26 to the driving device 34 of said cutting means 33, said information signals being dependent on the marks M2a and/or M2b read on the web portions 2a and/or 2b or corresponding holes in the web portions 2a, 2b, i.e. on reading signals 27 and/or 28 transmitted by the reading devices 24 and/or 25 to the control unit 26 when they read said marks m2a and/or M2b or corresponding holes.

The reading devices 24, 25 may either be photoelectric, reading the marks M2a, M2b, or so called spiked rollers which engage said holes (not shown) in the web portions 2a, 2b and thereby read the positions of the web portions 2a, 2b relative to the various working devices.

There may also be a feeding unit 35 for feeding the web portions 2a, 2b to the twin-web device 4. This feeding unit 35 includes, in the illustrated embodiment, at least a friction roll 36 and a counter-pressure roll 37 between which the web portions 2a, 2b run or pass for transport in the running direction T.

The feeding unit 35 may further include a driving device 39 for driving the friction roll 36 or the feeding means 38. This driving device 39 may be controlled by control signals 40 from the control unit 26 and is dependent on the information signals from the high-speed printer 1.

There may also be a loop sensing device 42 known per se and sensing loops 2aa and 2bb of the web portions 2a, 2b as well as controlling means for stretching or slacking the web portions 2a, 2b in dependence of how much the loops 2aa, 2bb are hanging down.

By means of the method and device described above it is achieved that the unseparated web 2 is cut in two web portions 2a, 2b, the widths B2a, B2b of which check or agree exactly with each other also if the width B of the unseparated web 2 varies and/or changes. The unseparated web 2 may vary and/or change for many reasons. If e.g. the unseparated web 2 is a paper web, the width B thereof may be changed because the degree of moisture in the web is changed. The invention further permits safe and effective feeding and cutting of the web portions 2a, 2b.

The invention is not limited to the method and device described above, but may vary within the scope of the subsequent claims. As examples not described in more detail it should be mentioned that the web 2, instead of a paper web, may be a plastic web or a web of another material. The unseparated web 2 can be cut in more than two web portions and it may be cut in two web portions 2a, 2b having different widths B2a, B2b. The extent of the displacement of the cutting means 7 may vary and depend on the desired widths B2a, B2b of the two web portions 2a, 2b. The cutting means 7 is preferably a rotating roller and it can be displaced laterally S on on the shaft 7a instead of moving the shaft 7a laterally together with the cutting means 7. It should finally be mentioned that said sensing devices may be photosensors or other types of sensors. The cross cutting device 6 may be of another type than rotating and said signals can be control and/or information signals.

1. Method at longitudinal cutting of a running, unseparated web in at least two web portions,
wherein the unseparated web (2) is printed in a high-speed printer (1), and
wherein the unseparated web (2) is cut longitudinally in at least said two web portions (2a, 2b) by means of a cutting means (7),
characterized in
that the unseparated web (2) is brought to run between a first and a second edge support (8, 9) such that longitudinal outer edges (2d, 2e) of the unseparated web (2), extending in the running direction (T), can cooperate with said edge supports (8, 9),
that at least when the width (B) of the unseparated web (2) varies and/or changes, this variation and/or change is read, and
that the second edge support (9) and the cutting means (7) are continuously controlled to move in a lateral direction (S) relative to the running direction (T) of the unseparated web (2) and in dependence of said continuously read variations and/or changes of the width (B) of the unseparated web (2), such
that incorrect cutting of the running, unseparated web (2) is avoided if the width (B) thereof varies and/or changes.

2. Method according to claim 1, characterized in that continuous reading of the width (B) of the unseparated web (2) is carried through by continuously reading the position of the second longitudinal outer edge (2e) of the unseparated web (2) relative to the first edge support (8) and that, if variations and/or changes of the width (B) of the unseparated web (2) is determined by a change of the position of the second longitudinal outer edge (2e) of the unseparated web (2) relative to the first edge support (8), the position of the second edge support (9) as well as of the cutting means (7) relative to the first edge support (8) is continuously changed in dependence of the extent or size of the read variations and/or changes of the width (B) of the unseparated web (2).

3. Method according to claim 1, characterized in that the unseparated web (2) is cut in at least two web portions (2a, 2b) with the same width (B2a, B2b) and that the cutting means (7) is moved relative to the first edge support (8) in dependence of read variation and/or change of the width (B) of the unseparated web (2) such that the cutting means (7) cuts the unseparated web (2) in two web portions (2a, 2b) with the same width (B2a, B2b)

4. Method according to claim 1, characterized in that the unseparated web (2) is brought to run between a first fixed edge support (8) and a second edge support (9) which is movable in a lateral direction (S) relative to the running direction (T) of the unseparated web (2).

5. Method according to claim 1, characterized in that changes of the position of one outer edge (2e) of the unseparated web (2) relative to the first edge support (8) are read continuously by means of a reader device (10), that change signals (11) are transmitted from the reader device (10) to a control device (12), whereby the change signals (11) are depending on changes of the extent or size of variations and/or changes of the position of said outer edge (2e), that control signals (15) are transmitted to a driving device (13), forming part of the control device (12), for moving the second edge support (9) relative to the first edge support (8) in dependence of the size or magnitude of said change signals (11) and that control signals (16) are transmitted to the driving device (13), forming part of the control device (12), for moving or displacing the cutting means (7) relative to the first edge support (8) in dependence of the size or magnitude of said change signals (11).

6. Method according to claim 5, characterized in that the cutting means (7) is moved relative to the first edge support (8) by displacement by means of the driving device (13) of a shaft (7a) on which the cutting means (7) is provided.

7. Method according to claim 1, wherein the web portions (2a, 2b) are brought to run above each other, characterized in that marks (M2a, M2b) or holes in the web portions (2a, 2b) are read, that at least one friction roll (18, 20) is controlled to measure each web portion (2a, 2b) in dependence of said reading and that the web portions (2a, 2b) are cut to double face products (2c) in dependence of said reading.

8. Method according to claim 7, characterized in that the running speed of a web portion (e.g. 2a) is regulated relative to the running speed of another web portion (e.g. 2b) if marks (M2a, M2b) on the various web portions (2a, 2b), when read, do not pass predetermined locations at predetermined times.

9. Method according to claim 7, characterized in that at least one friction roll (36) for feeding the web portions (2a, 2b) to a twin-web device (4) wherein the web portions (2a, 2b) are provided to run above each other as a twin web, is controlled in dependence of control signals (40) from a high-speed printer (1).

10. Method according to claim 7, characterized in that the friction rolls (18, 20) for feeding the web portions (2a, 2b) are driven by one and the same drive unit (22), that a friction roll (18) for feeding a web portion (e.g. 2a) is driven by the drive unit (22) through a rotary-speed regulating device (23) which increases or decreases the rotary speed of said one friction roll (e.g. 18) relative to the rotary speed of the other friction roll (e.g. 20) and brings thereby one web portion (e.g. 2a) to run at a higher or lower running speed than the other web portion (e.g. 2b) for restoring deviations in the running speeds of the web portions (2a, 2b) and thereby the mutual positions of parts belonging to each other of said web portions (2a, 2b).

11. Device at longitudinal cutting of a running, unseparated web in at least two web portions,
wherein the unseparated web (2) is printed in a high-speed printer (1), and
wherein at least one cutting means (7) is provided 10 to cut the unseparated web (2) longitudinally in at least said two web portions (2a, 2b),
characterized in
that the device comprises a first and a second edge support (8, 9) between which the unseparated web (2) is brought to run in the running direction (T) such that longitudinal outer edges (2d, 2e) of the unseparated web (2) can cooperate with said edge supports (8, 9),
that a reader device (10) is provided to continuously read if the width (B) of the unseparated web (2) varies and/or changes, and
that a control device (12) is provided to continuously control the second edge support (9) and the cutting means (7) to continuously move in lateral directions (S) relative to the running direction (T) in dependence of such variations and/or changes of the width (B) of the unseparated web (2) which have been read by the reader device (10), so
that incorrect cutting of the running, unseparated web (2) is avoided if the width (B) thereof varies and/or changes.

12. Device according to claim 11, characterized in that the reader device (10) is provided to continuously read the width (B) of the unseparated web (2) by continuously reading the position of a second outer edge (2e) of the unseparated web (2) relative to the first edge support (8), that the reader device (10) is provided to transmit change signals (11) to the control device (12), said change signals (11) being dependent on the extent or size of variations and/or changes of the width (B) of the unseparated web (2), and that the control device (12) is provided to control, in dependence of said size-dependent change signals (11), the second edge support (9) as well as the cutting means (7) to adapt their positions to the varied and/or changed width (B) of the unseparated web (2).

13. Device according to claim 12, characterized in that the control device (12) includes a driving device (13) which is provided to move the second edge support (9) as well as the cutting means (7) in a lateral direction (S) relative to the running direction (T) of the unseparated web (2) and relative to the first edge support (8).

14. Device according to claim 13, characterized in that the driving device (13) comprises a first drive unit (13a) for moving the second edge support (9) relative to the first edge support (8) and a second drive unit (13b) for moving the cutting means (7) relative to the first edge support (8).

15. Device according to claim 14, characterized in that the cutting means (7) is provided on a shaft (7a) and that the second drive unit (13b) is provided to displace said shaft (7a) in a lateral direction (S) relative to the running direction (T) of the unseparated web (2).

16. Device according to claim 11, characterized in that the cutting means (7) is provided to divide the unseparated web (2) into two web portions (2a, 2b) having the same width (B2a, B2b) and that the control device (12) is provided to control the cutting means (7) such that said cutting means (7), when the width (B) of the unseparated web (2) varies and/or changes, is moved in dependence of said change so that it cuts the unseparated web (2) in two web portions (2a, 2b) with the same width (B2a, B2b).

17. Device according to claim 11, wherein the web portions (2a, 2b) in a twin-web device (4) are brought to run above each other as a twin web,
characterized in
that reader devices (24, 25) are provided to read marks (M2a, M2b) on the web portions (2a, 2b) in order to
a) control friction rolls (18, 20) which are adapted to feed the web portions (2a, 2b) in a running direction (T) in dependence of said reading, and
b) control a cross cutting device (6) for cutting the web portions (2a, 2b) to products (2c) in dependence of said reading.

18. Device according to claim 17, characterized in that at least one drive unit (22) is provided to operate the friction rolls (18, 20), that the sensing devices (24, 25) are provided to sense when marks (M2a, M2b) or holes in the two web portions (2a, 2b) pass in order to determine if parts belonging to each other of the web portions (2a, 2b) are in correct relationship to each other and to transmit reading signals (27, 28) if this is not the case, that the drive unit (22) is provided to transfer generated rotary motions directly to one (20) of the friction rolls (18, 20) and transfer said rotary motions to the other (18) of said friction rolls (18, 20) through a rotary-speed regulating device (23) which is provided between the drive unit (22) and said other friction roll (18) for increasing or decreasing the rotary speed of said latter friction roll (18) relative to a rotary speed of said first friction roll (20) and that the rotary-speed regulating device (23) is controlled by control signals (30) which are dependent on said reading signals (27, 28) for increasing or decreasing the rotary speed of one friction roll (e.g. 18) such that deviations in the running speeds of the web portions (2a, 2b) and thus, deviations in the mutual positions of the parts belonging to each other of said web portions (2a, 2b) are restored.

19. Device according to claim 17, characterized in that at least one friction roll (36) in a feeding unit (35) is provided to feed the web portions (2a, 2b) to the twin-web device (4) and that said friction roll (36) is controlled by control signals (40) from the high-speed printer (1)

20. Device according to claim 17, characterized in that the cross cutting device (6) comprises a rotating cutting means (33).
